(19) United States
(12) Patent Application Publication
(10) Pub. No.: US 2019/0240842 A1
(43) Pub. Date: Aug. 8, 2019

(54) ROBOT ASSISTED INTERACTION SYSTEM AND METHOD THEREOF

(71) Applicant: YongLin Biotech Corp., New Taipei (TW)

(72) Inventors: MING-HSUN HSU, New Taipei (TW); CHENG-YAN GUO, New Taipei City (TW); YAO-TSUNG CHANG, New Taipei (TW); CHIA-HUNG KUO, New Taipei (TW)

(21) Appl. No.: 16/261,574

(22) Filed: Jan. 30, 2019

(30) Foreign Application Priority Data
Feb. 8, 2018 (TW) 107104579

(51) Int. Cl. B25J 11/00; H04W 76/10; H04W 4/80; G06F 3/01; G06F 3/0488; G06F 3/16; H04N 5/225; B25J 9/16

(52) U.S. Cl. CPC B25J 11/0005; H04W 76/10; H04W 4/80; G06F 3/017; B25J 9/1697; G06F 3/167; H04N 5/2253; B25J 9/1694; G06F 3/04883

(57) ABSTRACT

A robot assisted interactive system comprises: a mobile device having a display unit for displaying visual content, a touch control unit for receiving user input, a camera unit for obtaining user reaction information, a communication unit for transmitting the use reaction information to a backend server, and a processing unit for controlling the abovementioned units; a robot that includes a gesture module for generating gesture output according to the visual content, a speech module for generating speech output according to the visual content, a communication module for establishing connection with a backend server, and a control module for controlling the abovementioned modules; and a backend server configured to generate a feedback signal in accordance with the reaction information and send it to the mobile device; so as to update the visual content on the mobile device, and cause the robot to generate updated gesture output and speech output.

### CROSS-REFERENCE TO RELATED APPLICATIONS

This application claims priority to Taiwanese Invention Patent Application No. 107104579 filed on Feb. 8, 2018, the contents of which are incorporated by reference herein.

### FIELD

The present invention relates to a robot assisted interactive system and method of using the same, and more particularly to a system and method for operating a mobile device with interactive speech and gesture assistance from a robot.

### BACKGROUND

Mobile devices such as cell phones and tablets greatly increase the convenience of people's lives. A wide range of applications is currently available for mobile devices to replace various traditional tools. For instance, there are currently many types of educational applications that utilize the multimedia functionalities of the mobile devices, turning them into powerful and effective tools for children education. In the meantime, there are new breeds of commercial robots (such as Pepper) capable of assisting and enhancing children learning experience. However, children may suffer from attention loss or frustration in the learning process due to lack of interaction or flexibility (e.g., monologue lecturing or rigid setting of content difficulties). Existing mobile devices or robots often does not provide interactive content adjustments according to children's real-time in-lesson conditions (e.g., emotional condition), resulting in a less than satisfactory learning experience.

Accordingly, there is a need for a more effective method to enhance the level of interaction with the learning applications provided by the mobile devices to increase learning effectiveness for children.

### SUMMARY

In view of this, one aspect of the present disclosure provides a robot assisted interactive system and method of using the same. The instantly disclosed robot assisted interactive system and method thereof facilitate deeper interaction between a user and the content of a mobile device (e.g., health & educational tutorial/material) with the help of a robot. By way of example, the robot assisted interactive system and method thereof of the present disclosure utilizes a robot or a mobile device to obtain a user's reaction feedback, and determine the state of the user through processing the feedback information by a backend server. The backend server may then generate a updated content material accordingly, and feed the updated content back to the mobile device and the robot, so as to enhance the user's interaction experience and thus achieve better education and learning results.

Accordingly, embodiments of the instant disclosure provides a robot assisted interactive system that comprises a robot, a mobile device, and a backend server. The mobile device includes a display unit, a touch control unit, a camera unit, a communication unit, and a processing unit. The display unit is configured to display a visual content. The touch control unit is configured to receive user input. The camera unit is configured to obtain user reaction information. The communication unit is configured to establish data connection with the backend server and transmit the use reaction information thereto. The processing unit is coupled to and configured to control the display unit, the touch control unit, the camera unit, and the communication unit. The robot includes a gesture module, a speech module, a communication module, and a control module. The gesture module is configured to generate a gesture output according to the visual content. The speech module is configured to generate a speech output according to the visual content. The communication module is configured to establish data connection with the backend server. The control module is coupled to and configured to control the gesture module, the speech module, and the communication module. The backend server is configured to generate a feedback signal in accordance with the reaction information and send the feedback signal to the mobile device; so as to cause the mobile device to update the visual content based on the feedback signal, and cause the robot to generate updated gesture output and speech output based on the updated visual content.

Embodiments of the instant disclosure further provides a method of robot assisted interaction using a robot assisted interaction system that includes a robot, a mobile device, and a backend server. The method comprises the following processes: establishing data connection between the mobile device and the robot; displaying, on the mobile device, a first visual content, wherein the robot generates a first speech output and a first gesture output based on the first visual content; determining, by the mobile device, a receipt of a user input signal; upon receipt of the user input signal by the mobile device, displaying on the mobile device a second visual content based on the user input signal, wherein the robot generates a second speech output and a second gesture output based on the second visual content; obtaining a use reaction information; sending the user reaction information to the backend server; generating a feedback signal, by the backend server, based on the user reaction information, and sending the feedback signal to the mobile device; and displaying, on the mobile device, a third visual content, wherein the robot generates a third speech output and a third gesture output based on the third visual content.

Accordingly, the instant disclosure provides a robot assisted interactive system and method of facilitating deeper interaction between a user and the content of a mobile device (e.g., health & educational tutorial/material) through the utilization of a robot. The robot assisted interactive system and method thereof of the present disclosure uses a robot or a mobile device to obtain a user's reaction feedback, and determine the state of the user through processing the feedback information by a backend server and generate a updated content material accordingly, and feed the updated content back to the user interface (e.g., the mobile device or the robot), so as to enhance the user's interaction experience and achieve better education and learning results.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 shows a schematic diagram of a robot assisted interactive system according to a first embodiment of the present disclosure.

FIG. 2 shows a block diagram of a robot assisted interactive system according to a first embodiment of the present disclosure.

FIG. 3 is a flow chart of a robot assisted interaction method according to a first embodiment of the present disclosure.

FIG. 4 is a schematic diagram of a robot assisted interactive system according to a second embodiment of the present disclosure.

FIG. 5 shows a block diagram of a robot assisted interactive system according to a second embodiment of the present disclosure.

### DETAILED DESCRIPTION

Embodiments of the instant disclosure will be specifically described below with reference to the accompanying drawings. Like elements may be denoted with like reference numerals.

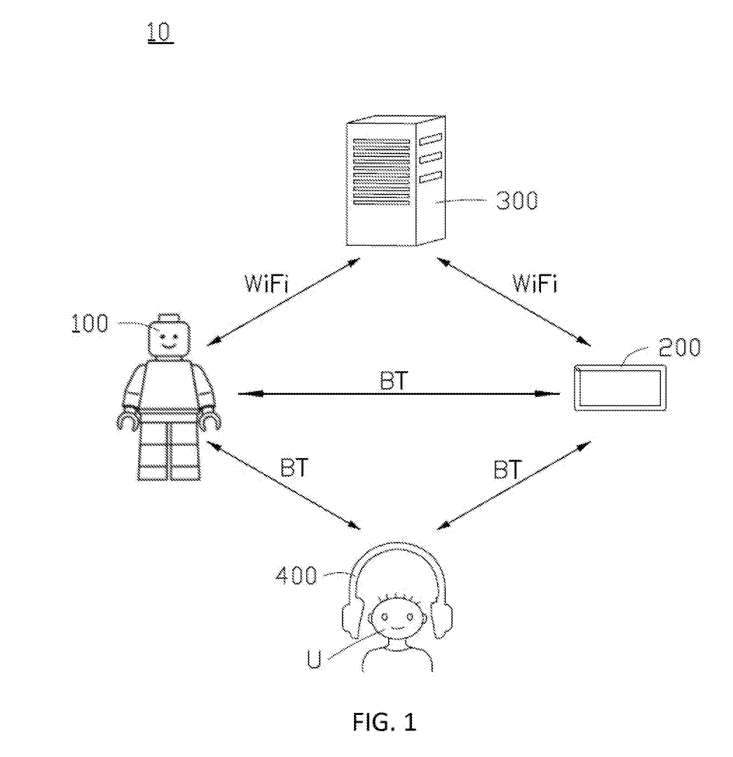

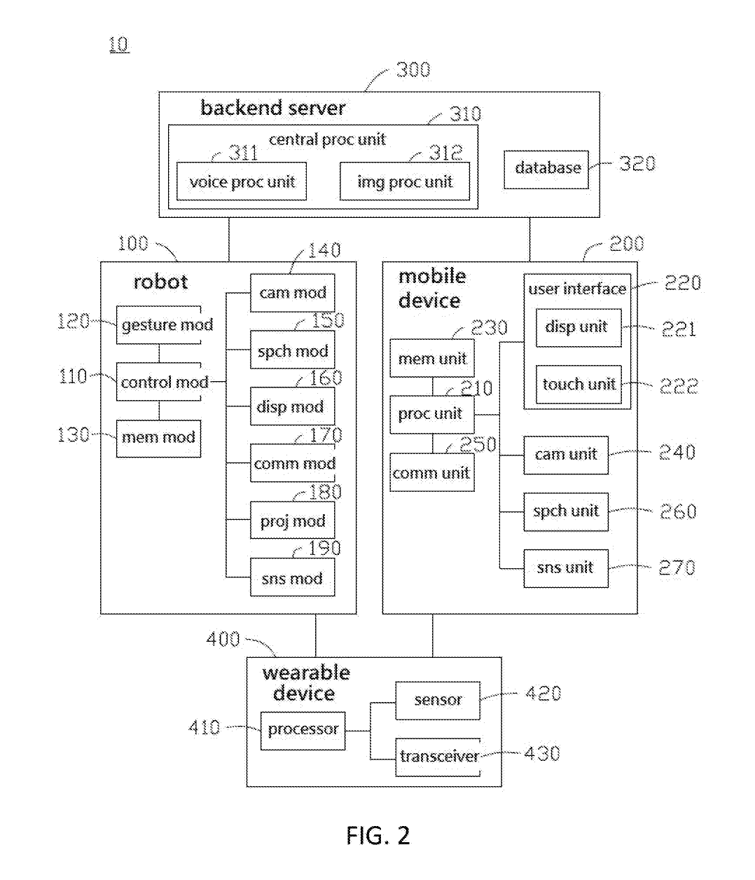

Please refer to FIG. 1 and FIG. 2, where FIG. 1 shows a schematic diagram of a robot assisted interactive system according to a first embodiment of the present disclosure, and FIG. 2 is a block diagram of a robot assisted interactive system according to a first embodiment of the present disclosure. The exemplary robot-assisted interactive system may be used to assist users in learning and interacting, e.g., to help children learn general health education knowledge, such as learning how to protect teeth from tooth decay. As shown in FIG. 1 and FIG. 2, the exemplary robot assisted interactive system 10 includes a robot 100, a mobile device 200, and a backend server 300. The mobile device 200 can be a general portable computing device such as a smart phone, a tablet or a laptop. A user U can install and use various mobile applications (APPs) provided on the mobile device 200 to conduct learning sessions (e.g., taking common health education lessons), and can interact with the APP through operating the user interface of the mobile device. As shown in FIG. 2, the mobile device 200 includes a user interface 220. The user interface 200 includes a display unit 221 and a touch control unit 222. The mobile device 200 includes a camera unit 240, a communication unit 250, and a processing unit 210. The display unit 221 is configured to display a visual content. The touch control unit 222 is configured to receive a user input and generate an input signal accordingly. The camera unit 240 is configured to obtain user reaction information. The user reaction information may include image information and voice information of a user captured during his/her operation of the mobile device 200 or interaction with the robot 100. The camera unit 240 may include a camera unit (and a microphone unit, if applicable) of a general smart phone, a tablet or a laptop computer, and has the functions of photographing and video recording, which can be used to obtain image information and sound information. The communication unit 210 is configured to establish data connection with the robot 100 and the backend server 300 through wired or a wireless networks, so as to transmit the obtained user reaction information thereto. In addition, the communication unit 210 may receive information from the robot 100 or the backend server 300, e.g., receives user information from the backend server 300. The processing unit 210 is coupled to and is configured to control the display unit 221, the touch unit 222, the image capturing unit 240, and the communication unit 250. The mobile device 200 may further include other components, for example, including a power supply unit (not shown), a voice unit 260, a memory unit 230, and a sensing unit 270. The power supply unit, such as a lithium battery and a charging interface, is used to supply power to the mobile device 200. The speech unit 260 may include a speaker for playing voice or music. The memory unit 230 may be a non-volatile electronic storage device used to store information. The sensing unit 270, which may include motion sensor or infrared detector, is configured to obtain environmental information around the mobile device 200.

Referring to FIG. 1 and FIG. 2, in the instant embodiment, the robot 100 is a small humanoid robot. The robot applicable in the instantly disclosed system is not limited to a humanoid robot. In other embodiments, the robot can be any robot that can perform guiding function for a user, such as a multi-legged, wheeled, or even non-mobile type companion robot. In the instant embodiment, the robot 100 may be placed on a tabletop to guide the user U (or attract the attention thereof) with sound and motion/gesture outputs. The robot 100 includes a gesture module 120, a speech module 150, a communication module 170, and a control module 110. The gesture module 120 is configured to instruct the robot to perform a physical motion/gesture output, e.g., in association with the visual content displayed on the mobile device 200. As shown in FIG. 1, the humanoid robot may comprise a multi-motor module that drives the four limbs thereof (e.g., a pair of arms and legs). The gesture module 120 is configured to generate control signals to coordinate the multi-motor module and direct the robot to generate arm motions (e.g., perform arm gestures), as well as leg movements (e.g., walking, standing, and kneeling). The speech module 150 is configured to generate a voice output, e.g., in association with the visual content displayed on the mobile device 200. For instance, in an exemplary scenario, during the starting up of the mobile device 200 where the display unit 221 shows an initialization (e.g., login) screen of an APP, upon a successful login of a user into the application, the gesture module 120 may direct the robot to perform a hand waving motion. Meanwhile, the speech module 150 may direct the robot to output a vocal greeting by calling out the user's name. The communication module 170 is configured to establish data connection between the mobile device 200 and the backend server 300 through a wireless network. The communication module 170 may include a mobile network module for establishing data connection through a mobile network under GSM 4G LTE. The communication module 170 may further include a wireless module for connecting to the mobile device 200 through WiFi or Bluetooth (BT). The control module 110 is coupled to and is configured to control the gesture module 120, the speech module 150, and the communication module 180. The robot 100 further includes a camera module 140, a display module 160, a projection module 180, a memory module 130, a sensing module (not shown), a microphone module (not shown), and a power supply module (not shown). The camera module 140 is configured to capture still and motion images. The camera module 140 may also have the capability to capture infrared images to capture images in a low light environment. The microphone module is configured to obtain sound information. The camera module 140 and the microphone module can be used to obtain the user response information, e.g., the camera module 140 is configured to acquire user image information; and the microphone module is configured to acquire the user audio information. The projection module 180 can be a laser projector module for projecting an image, for example, projecting a QR code. The mobile device 100 may scan the QR code to establish connection to the robot 100. The display module 160 may be a touch display module arranged onboard (e.g., in the back of) the robot 100 for controlling and displaying information thereof. The memory module 130 may be an electronic non-volatile storage device configured to store information. The sensing module may include, e.g., a motion sensor, configured to sense the surrounding environment or the status/orientation of the robot 100 itself. The power supply module may include a rechargeable lithium battery for supplying power to the robot 100. In addition to the above components, the robot 100 may further include a positioning module for receiving/recording position information thereof, which may include assisted global positioning system (A-GPS), global navigation satellite system (GLONASS), digital compass (Digital Compass), gyroscope, accelerometer, microphone array, ambient light sensor, and charge-coupled device.

In one embodiment, the robot 100 may ascertain its global latitude and longitude positions through an assisted global positioning system (A-GPS) or a global navigation satellite system (GLONASS). In the positioning of the regional space, the user may obtain an orientation status of the robot 100 through a digital compass. Likewise, an angle of the deflection of the robot 100 can be obtained by using an electronic gyroscope or an accelerometer. In some embodiments, a microphone array and ambient light sensor may be integrated as robot sensors to obtain relative motion/position of environmental objects around the robot 100, so can a charge-coupled device be used to obtain a two dimensional array of digital signal. The control module 110 of the robot 100 can perform three-dimensional positioning by using the spatial features of the acquired two-dimensional array of digital signals.

Referring to FIG. 1 and FIG. 2, the backend server 300 is configured to generate a feedback signal based on the user response information. During operation, the backend server 300 transmits the feedback signal to the mobile device 200. Accordingly, the mobile device 200 then updates the image content based on the feedback signal. The robot 100 generates an updated gesture output and speech output in accordance with the updated image content. In the exemplary embodiment, the backend server 300 includes a central processing unit 310 and a database 320. The central processing unit 310 is capable of processing the user response information from the mobile device 200 or the robot 100, and generating the feedback signal. As described above, the user response information includes user image information and user voice information. The central processing unit 310 includes a voice processing unit 311 and an image processing unit 312. The voice processing unit 311 is configured to process the user voice information, and the image processing unit 312 is configured to process the user image information. In addition, the voice processing unit 311 can also be used to recognize a user's identity by using the sound information. Likewise, the image processing unit 312 can also be used to identify the user's identity by using the image information, such as face recognition, fingerprint recognition, iris recognition, and the like. The aforementioned database 320 is used to store user information such as name, age, preference, usage history, and the like. After the user U logs into the APP application, the backend server 300 may transmit the user data stored in the database 320 to the mobile device 200. The backend server 300 can further include a user operation interface, a communication unit, and a memory temporary storage module and other components (not shown).

Referring to FIGS. 1 and 2, the exemplary robot assisted interactive system 10 further includes a wearable device 400. The wearable device 400 includes a sensor 420, a transceiver 430, and a processor 410. The sensor 420 is configured to sense a user's physiological feature and obtain associated physiological information. The communicator 430 is configured to establish data connection with the mobile device 200 and transmit thereto the user physiological information. The transceiver 430 may be a wireless device capable of connecting to other devices (such as the mobile device 200) through WiFi or Bluetooth. The processor 410 is coupled and configured to control the sensor 420 and the transceiver 430. The wearing device 400 may further include a dry battery to supply power thereto. The wearable device 400 may monitor the physiological conditions of a user (e.g., information regarding blood pressure, heartbeat, brain wave, blood oxygen), and transmit the user's physiological information to the mobile device 200 and the backend server 300. The backend server 300 calculates a preferred interactive solution according to the physiological information of a user, and feeds back the mobile device 200, so that the mobile device 200 may provide image contents that are better suitable to the current condition of the user. In addition, the feedback from the user physiological information may enable the robot 100 to present more interactive gesture and speech output, so as to enhance the user's interaction experience with the mobile device 200. In one embodiment, the wearable device 400 is a brain wave detection (e.g., electroencephalogram) and analysis device; and the sensor 420 is a brain wave detection electrode module. The brain wave detecting electrode module can be attached to the left and right forehead or the back of the user U for detecting the brain wave signal thereof. The processor 410 may filter and extract the obtained brain wave signals, which may include suitable filters (e.g., band-pass or band stop filters) of suitable frequency bands, e.g., Delta (0-4 Hz), Theta (4-7 Hz), Alpha (8-12 Hz), and Beta (12-30 Hz), and Gamma (30+ Hz) bands, etc. The values of the physiological features are used to analyze the composition ratio between the Dominant Frequency and each of the frequency bands, so that applicable algorithm may be used in conjunction to determine the degree of concentration of the user U.

In one embodiment, the blood pressure, heartbeat, and blood oxygen data of the user U measured by the wearable device 400 can be associated with the physiological state of the user during a game. The level of concentration of the user may be determined through analyzing the various physiological data using applicable algorithms. According to studies, when a user is distracted, the number of heartbeats will rise, blood pressure will also increase, and the amount of blood oxygen in the brain will decrease. Conversely, if a user's concentration is high, the number of heartbeats will decrease, the blood pressure will maintain at a calm state, and blood oxygen level in the brain will increase. Through suitable analytical algorithm(s), the three types of physiological signals can be used to determine the degree of concentration of the user's when answering questions (as well as the stress level of a user in association with the difficulty level of the questions). Accordingly, the system may use the analytical results to interactively adjust the difficulty level of subsequent question, so as to suit the user's current condition to retain the attention thereof (e.g., by reducing the level of frustration thereof; after all, some educational programs are more effective by learning through playing).

In some embodiments, as shown in FIG. 1, data connection from the robot 100 and the mobile device 200 to the backend server 300 is established through WiFi, while the connection from the robot 100 and the mobile device 200 to the wearable device 400 is established through Bluetooth.

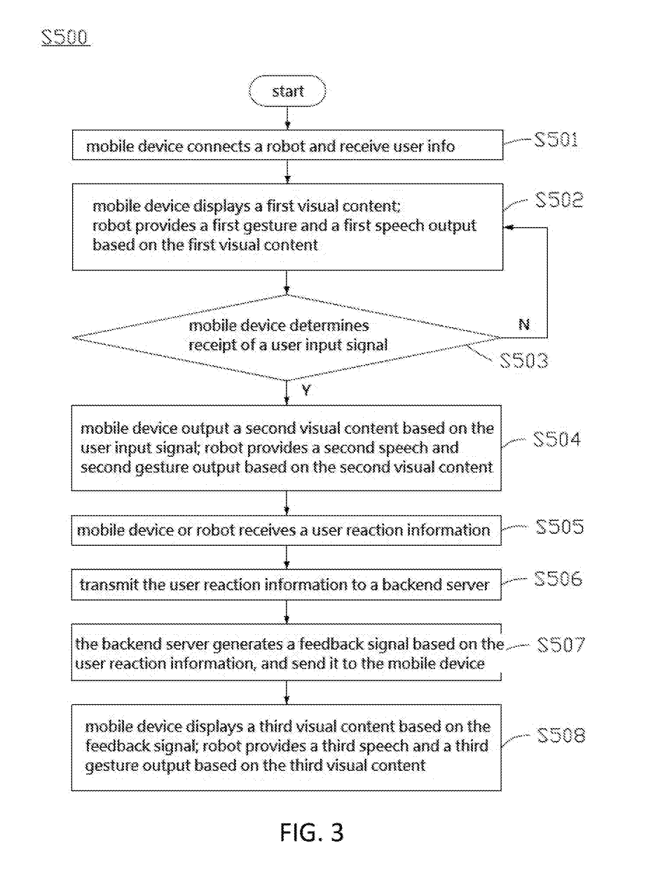

Please refer to FIG. 2 and FIG. 3. FIG. 3 is a flowchart of the robot assisted interaction method in accordance with one embodiment of the present disclosure. As shown in FIG. 2 and FIG. 3, the exemplary robot assisted interaction method S500 is applicable to a robot assisted interactive system (e.g., system 10). The robot assisted interactive system 10 includes a robot 100, a mobile device 200, and a backend server 300. The components and modes of operation of the robot assist system 10 are as described above, and will not be described herein. The robot assisted interaction method S500 includes processes S501 to S508. In process S501, the mobile device 200 establishes connection with the robot 100. For example, the display module 160 of the robot 100 may display a QR Code, and a user may scan the QR code with the mobile device 200 to establish connection between the mobile device 200 and the robot 100. Alternatively, the projection module 180 of the robot 100 can project the QR Code to facilitate the scanning by the mobile device 200. Alternatively, a sticker having the QR Code printed thereon may be attached to the body of the robot 100 to enable easy scanning by the mobile device 200. The QR code may contain identification information about the robot 100, such as serial number, name, placement position, low power Bluetooth address (BLE Address), WiFi MAC address, and IP address. Alternatively, the robot 100 may perform scanning of the QR code generated by the mobile device according to the user information for establishing connection. If the QR Code is not used, the general device might not be able to search for the robot 100 because the default WiFi and Bluetooth settings of the robot 100 may be in hidden mode. Moreover, each different robot can preset a unique PIN code to ensure the security of connection, so as to avoid interference and malicious intrusion. Process S501 may further include a process that allows a user to input user information through the user interface 220 of the mobile device 200. For example, the user can input the account information of thereof on the user interface of the mobile device 200. Alternatively, the mobile device 200 may capture and analyze an image or sound recording of a user and transmits the information to the backend server 300 for user identification/recognition. Process S501 may further include a process where the mobile device 100 receives user information from the database 320 of the server 300. The user information may include, for example, name, age, preference, usage history, and the like. In another embodiment, the foregoing user information may be pre-stored in the memory unit 230 of the mobile device 100.

In process S502, the mobile device 200 displays a first visual content; the robot 100 provides a first speech output and a first gesture output according to the first visual content. For example, after the user connects the mobile device 200 to the robot 100, the application (APP) is initiated, and the first visual content on the mobile device 200 may show a start screen that includes a welcome message for the user. Concurrently, the robot 100 can perform a hand waving motion as the first gesture output, and simultaneously call out the user name (or nickname) as first speech output. It can further generate a reminder for the user to click on the mobile device 200 to start interaction. Accordingly, the motion gesture and speech output of the robot 100 can be synced and matched to the visual output displayed on the mobile device 20, thereby increasing the level of user immersion during the interaction process. This would help to increase a user's fun factor when interacting with the mobile device 200 and retain user's attention for continued interaction.

In process S503, the mobile device 200 determines whether a user input signal is received. For example, after the user launches the APP, the user may carry out interactive functions of the application through touch control. The processing unit 210 of the mobile device 200 may determine whether the touch unit 222 has received a touch operation from a user. When the determination in S503 is NO, that is, if the mobile device 200 does not receive a user input signal, the process returns to S502 to remind the user to interact with the mobile device 200. On the other hand, when the determination in S503 is YES, that is, the mobile device 200 receives a user input signal, the process proceeds to S504. At this time, the user may start to interact with the mobile device 200 by using the touch control interface 220. For example, the user may touch the option icons provided on the user interface 220.

In process S504, the mobile device 200 may display a second visual content based on the user input signal. Meanwhile, the robot 100 would provide a second speech output and a second gesture output in association with the second visual content. For example, in a scenario where the user selects a right answer when using the APP, the mobile device 200 may display a smiling face as a second visual content. Concurrently, the robot 100 may generate a speech output “right answer, congratulations!” and perform a clapping motion with its arms raised over its head as the second speech and gesture outputs. In another scenario where the user selects a wrong answer, the mobile device 200 may display a crying face as a second visual content. Accordingly, the robot 100 may generate a speech out “pity, wrong answer!” and perform a head shaking gesture with its hands down as the second speech and gesture outputs.

In process S505, the robot assisted system 10 obtains a user reaction information. The user reaction information may include user image information and user voice information. By way of example, the mobile device 200 may acquire user image information and user voice information through its onboard sensors. Alternatively, the robot 100 may be used to acquire user image information and the user voice information. For example, when a user learns that he or she selects a right answer, they would naturally put out a happy facial expression and sounds. Either one of the mobile device 200 or the robot 100 may record the user visual and sound expressions as user response information. Conversely, when a user learns that his/her answer is wrong, he/she would inevitably put out frustrated facial expression and sound. The mobile device 200 or the robot 100 would likewise record the depressed expression and sound of the user as user response information. In certain cases, the user may begin losing interest in the visual content shown on the mobile device 100, and starts to appear absent-minded. In turn, at least one of the mobile device 200 or the robot 100 may record the performance of the user's absent-mindedness as user response information. In process S506, the mobile device 200 or the robot 100 transmits the user response information to the backend server 300. In some embodiments, the robot assisted system 10 may further include a wearable device 400. Process S505 may further include: acquiring user physiological information by the wearable device 400 and transmitting the user physiological information to the backend server 300. In one embodiment, the wearable device 400 is an electroencephalogram detection and analysis device.

In process S507, the backend server 300 generates a feedback signal according to the user reaction information, and transmits the feedback signal to the mobile device 200. Specifically, after the backend server 300 obtains the user response information, the voice processing unit 311 and the image processing unit 312 in the backend server 300 analyze the user voice information and the user visual information to determine the status of the user. In addition, the backend server 300 generates the feedback signal according to the state of the user, and transmits the feedback signal to the mobile device 200. For example, when the backend server 300 determines that the user is in a happy state, the backend server 300 generates a feedback signal with enhanced difficulty and transmits the feedback signal to the mobile device 200. Alternatively, when the backend server 300 determines that the user is in a frustrated state, the backend server 300 may generate a feedback signal with reduced difficulty to transmit to the mobile device 200. Alternatively, when the backend server 300 determines that the user is in an absent-minded state, the backend server 300 may generate a feedback signal that attracts the user's attention and transmits the feedback signal to the mobile device 200. In another embodiment, the processing unit 210 of the mobile device 200 generates a feedback signal according to the user response information; that is, the mobile device 200 can directly analyze the user response information and generate a feedback signal. Process S507 further includes: the backend server 300 generates the feedback signal according to the user physiological information. In addition to determining the state of the user by using the user response information, the backend server 300 can further determine the state of the user by using physiological information of the user (for example, blood pressure, heartbeat, or brain wave). In one embodiment, the backend server 300 uses the brainwaves of the user to analyze the degree of concentration of the user.

In process S508, the mobile device 200 displays a third visual content according to the feedback signal. Also, the robot 100 provides a third speech output and a third gesture output according to the third image content. For example, when the backend server 300 generates a feedback signal indicating a need for increased difficulty to the mobile device 200, the mobile device 200 would correspondingly display content with higher difficulty as the third image content. Accordingly, the robot may generate a message “this question is tough, keep it up!” with a corresponding cheering motion as the third speech and gesture outputs. Alternatively, when the backend server 300 generates a feedback signal indicating a need for reduced difficulty and transmits the feedback signal to the mobile device 200, the mobile device 200 would in turn display a lower difficulty content as the third image content. According, the robot may generate a speech output “take it easy; let's try again” in conjunction with a cheering motion as the third speech and gesture outputs. Alternatively, when the backend server 300 generates a feedback signal that indicates a need for attracting the user's attention and transmits the feedback signal to the mobile device 200, the mobile device 200 may display a content designed to attract the user's attention as the third image content. For instance, the robot 100 may start to perform singing and dancing as the third speech and gesture outputs to regain the user's attention.

Accordingly, the robot assisted interaction method S500 of the instant disclosure utilizes a robot to guide the user interaction with the content provided by a mobile device (e.g., such as medical/health education). Moreover, the robot assisted interaction method S500 of the present disclosure utilizes a robot or a mobile device to obtain the user's reaction, and determines an emotional/mental state of the user through the processing power of the backend server. Such interactive scheme may generate better subsequent content or response for the system user through the provision of better, more suitable, and more interactive feedback contents, thereby achieving better learning results.

In addition to the above-described embodiments, additional embodiments will be described below to illustrate the robot assisted interaction method of the present disclosure. In one embodiment, when user beings using the robot assisted interactive system, the robot may automatically identify the user and obtain the user's usage record and usage progress. Accordingly, during subsequent voice interaction, the robot may directly call out the user's name (or nickname). For user identification, the aforementioned robot can recognize the user's identity through the facial features of the user. Alternatively, the aforementioned robot can access the data in the mobile device, the wearable device worn by the user, or the RFID to obtain the corresponding identification code, and then query the database of the backend server to obtain user information. If user information cannot be found in the database of the backend server, the robot can ask the user whether to create new user information. In addition, third parties, such as the hospital's Hospital Information System (HIS) or the Nursing Information System (NIS), may provide the user information. Alternatively, the user information may be obtained from the default user information of the mobile device.

In one embodiment, the robot can possess face recognition capability. The face database can be provided by a third party, such as a hospital's HIS system or NIS system. Alternatively, the face database may be preset in the memory unit of the mobile device or in the database of the backend server. The face recognition method of the robot may be determined based on the relative position information between a user's facial contour and part of a facial characteristic feature. The characteristic positions may include the eyes, the tail of the eyes, the nose, the nose, the mouth, the sides of the lips, the middle, the chin, the cheekbones and the like. In addition, after each successful facial recognition process, the face information of the user in the face database may be updated or corrected to address possible gradual changes in the user's body (e.g., gaining/losing weight).

In one embodiment, after user identification is completed, the mobile device establishes connection to the backend server to receive the user information and load the APP of the mobile device (e.g., a health education APP) to setup a learning progress (and to adjust a starting material). If the user is a first time user for the health education APP, the APP will set the user's attributes from an initial stage. The APP has several built-in educational modules and small games of different topics but within a common subject. Each time a user completes a health education module, the mobile device uploads the user's performance result to the aforementioned back end server. The server may accordingly record the user's learning result in a so-called fixed upload mode.

In one embodiment, when performing face recognition, an image of the user's eye portion is obtained for determining whether the user is tired, e.g., by using observable signs from the image as such whether the user's eyelid is down, the eye-closing time is increasing, or the eyes turn red, and the like. When the system determines that the user is feeling exhausted, the robot may ask the user whether to continue or advise the user to take a rest.

In another embodiment, a user can be equipped with a brain wave measuring device, and the brain wave measuring device can establish data connection with the mobile device and/or the robot. The current physiological status of the user may thus be obtained by determining the change in the users' brainwave. The brain wave measuring device measures the brain wave (also called Electroencephalography, EEG) of the user through contact of the electrodes on the scalp (such as the forehead). EEG can be used to determine a user's concentration level. Moreover, a user's attention can be captured/concentrated through playback of appropriate music. Generally, the frequency of brain waves can be classified (from low to high) into δ wave (0.5˜4 Hz), θ wave (4˜7 Hz), a wave (8˜13 Hz), β wave (14˜30 Hz). The a wave represents a person in a stable and most concentrated state; the β wave indicates that the user may be nervous, anxious or excited, and uneasy; the θ wave (4˜7 Hz) represents the user's in a sleepy state. In general, θ and δ waves are rarely detected in adults when they are awake or attentive. Therefore, the brain wave measuring device can be used to judge the user's state of concentration based on the detected alpha wave, theta wave and the delta wave, and such brainwave information may then be used to adjust the content of the APP in a timely manner to capture/ regain the attention of a user.

In an embodiment, taking the medical education APP as an example, this type of application is presented in a sequential simple graphical/textual question and answer (QA) manner. The QA bank/database is preloaded in the application and can be downloaded from the backend server via automatic update. When a user starts the educational APP, the type of question offered to the user may be determined by the user information obtained at the time of connection. The APP may adjust difficulty level of the questions based on the result of the user's previous answers. In this embodiment, during the interaction with the application, the mobile device and the aforementioned robot use the camera unit and the camera module to capture image information of the user's facial expression at a fixed frequency (for example, five times per second). The image information is then transmitted to the aforementioned backend server for analysis. In addition, brain wave detection and analysis device can be used to generate analytic data regarding the user's concentration level in combination with the user's image and voice information, as well as taking into account the recorded input rate of the user. The above measured information may then be integrated and transmitted to the aforementioned back-end server. The backend server uses the above information analysis to analyze the user's emotional condition and generate a continuous emotion-condition distribution curve, and transmits the result in a feedback signal back to the mobile device. Accordingly, the mobile device adjusts and selects the content of the next educational game according to the feedback signal. This feedback adjustment process may be repeated during the game progression to ensure that the provided content is better received by the user, i.e., enhancing the user's learning quality by retaining the user's attention.

In one embodiment, taking the medical education APPs for example, to accompany the teaching material displayed by the mobile device, the robot may simulate/emulate the gesture of a lecturing instructor, in order to assist a user in understanding the content of the educational material. Meanwhile, the camera module of the robot or the camera unit of the mobile device can be used to capture the user's mood and concentration state in real time, so that the robot can respond accordingly. Moreover, the mobile device transmits the emotion and concentration state of the user to the backend server as the basis for the subsequent content provision. If it is determined that the user is unable to concentrate, the robot may perform a dynamic motion, or provide a joke with singing/dancing gestures to capture the user's attention. In addition, the robot-assisted interactive system of the present disclosure also supports broadcast of the educational video and the video conferencing functionality that enables real-time communication between medical staffs and a user.

In one embodiment, the mobile device transmits the user's usage data to the backend server. After the back-end server accumulates sufficient usage data from different users, a user mode analysis can be performed and used as a basis for adaptive content adjustment. Taking medical education APP as an example, the mobile device may adjust the question selection from its preset bank based on the user information (e.g., age of the user) and the selected mode of the response. The adaptive content selection of the in-game question bank may be performed by the back-end server by analyzing the user's voice recognition, face recognition, emotion recognition, and brain wave detection data, and correspondingly generate a feedback signal. The mobile device and the aforementioned robot may correspondingly perform content selection based on the feedback signal, so as to prepare the next phase of interactive content. In addition, through online update, the backend server can also update the question displayed on the mobile device, as well as the voice and gesture of the robot. The back-end server may collect user response information as a basis for adjusting subsequent question/content, as well as for user mode/preference analysis. The above-mentioned medical education APP may also provide offline mode, which may be used to help users familiarize with the operation/functionality of the APP and provide real-time data query.

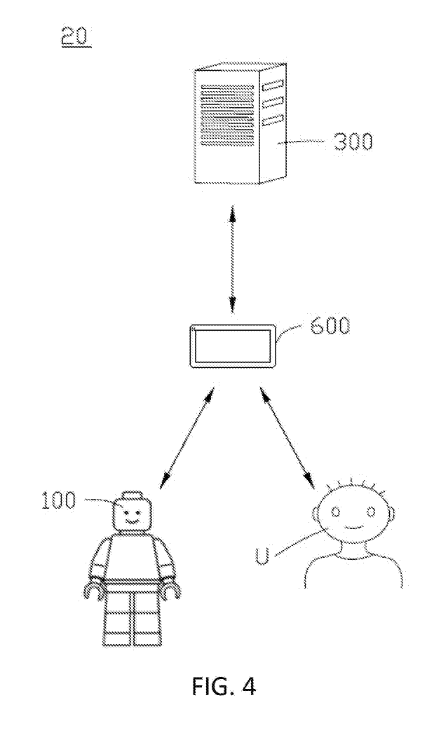

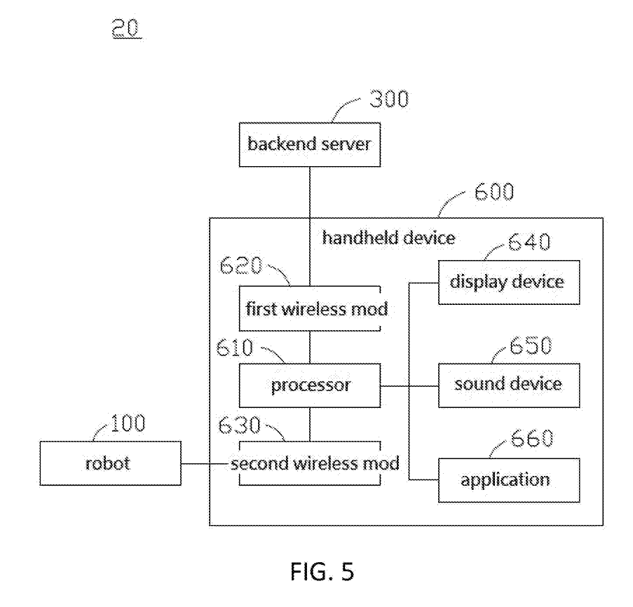

Please refer to FIG. 4 and FIG. 5. FIG. 4 is a schematic diagram of a robot assisted interactive system according to another embodiment of the present disclosure. FIG. 5 shows a block diagram of a robot assisted interactive system according to a second embodiment of the present disclosure. As shown in FIG. 4 and FIG. 5, the robot assisted interactive system 20 in accordance with the instant embodiment includes a robot 100, a backend server 300, and a handheld device 600. Detail of the robot 100 and the backend server 300 can be referred to the corresponding descriptions of FIG. 2, and therefore will not be repeated herein for the sake of brevity. The handheld device 600 may be a smart phone or a tablet (e.g., corresponding to the mobile device 200 shown in FIG. 2). The handheld device 600 may include a processor 610, a first wireless module 620, a second wireless module 630, a display device 640, and a sound device 650. The handheld device 600 may establish data communication with the backend server 300 through the first wireless module 620. In some embodiments, the first wireless module 620 is a WiFi module. The handheld device 600 may further establish connection with the robot 100 through the second wireless module 630. In some embodiments, the second wireless module 630 is a Bluetooth module (BT). The display device 640 may be used to display information or images. In some embodiments, the display device 640 is a touch display module that provides touch control capability. The sound device 650 may be a speaker for outputting sound. The handheld device 600 can further include at least one application 660, such as a medical education APP. The robot 100 of the robot interaction system 20 of the instant embodiment servers as the interaction interface for the user U, which is used to provide guidance to the user U on the operation of the one or more application 660 installed on the handheld device 600. In some embodiments, based on the operating condition of the user U, the system may perform reminder or warning message through the interaction/gesture performance of the robot 100 to prevent the user from prolonged continuous usage of electronic devices (which may be harmful to his/her health). In addition, onboard sensing device of the robot 100 (such as the sensing module 190 shown in FIG. 2) may be used to detect the state of the user, and correspondingly change the content of the application 660 displayed on the handheld device 600 (for example, the story of an interactive game).

When the user U executes the application 660 through the handheld device 600, the robot 100 may guide the user U to complete the interactive task of the application 660 using voice or gesture output. Reference can be made to the foregoing embodiments (the details may be referred to previous embodiment). The robot 100 may determine the state of the user U using onboard sensing devices, e.g., built-in microphone (such as the voice module 150 shown in FIG. 2), photographic lens (such as the camera module 140 shown in FIG. 2), and physiological sensing device (that is attached to the user, for example, the wearable device 400 shown in FIG. 2), and return the gathered user status information to the handheld device 600. The handheld device 600 may dynamically change the displayed material of the application 660 according to the state of the user. For example, if it is detected that the user is tired, the handheld device 600 may issue vocal or visual signal to reminder the user to take a break; or generate vocal or gestural message by the robot 100 to suggest the user to take a rest. If the user is detected to lack concentration, the handheld device 600 may initiate a small game or a fast-paced interactive task from the application 660 via the display device 640 to regain the user's attention. Alternatively, the handheld device 600 may initiate playback of different background music through the sound device 650.

After the user finishes a session, the processor 610 may record the usage status information and transmit the recorded data to the backend server 300 for future reference of the application 660. For instance, each application 660 executes a plurality of different types of units, and the aforementioned processor 610 or the aforementioned backend server 300 may changes the order of the different types of units according to the user's past usage records.

In one embodiment, when the robot 100 determines that the current state of the user is unfocused, inattentive, or distracted, the robot 100 may transmit user status information to the handheld device. The handheld device 600 may correspondingly stop the application or change the content of the subsequent application in a timely manner, or remind the user to take a break (e.g., followed the gesture of the robot 100 to perform stretching exercises). In some embodiments, the robot 100 may generate message to remind the user that the usage time is too long, recommend the user to take a break and rest his/her eyes. In the mean time, the application 660 on the handheld device 600 may temporarily pause its functionality for a predetermined period of time, or play a relaxing picture, music, or video.

In another embodiment, the user's usage status or operation record is gathered by the handheld device 600 and transmitted back to the backend server 300 for real-time or further adjustment of the displayed content of the interactive game or education software. Alternatively, the user's usage status or operation record can also be directly stored in the handheld device 600, and the settings can be linked to the corresponding application.

In one embodiment, the robot 100 may continuously capture a user's image through a built-in camera (for example, the camera module 140 shown in FIG. 2), and determine the user's condition/status based on the captured image. For example, the continuously captured user image is used to determine whether the user has his/her eyes shut or in a doze. When the situation occurs, the robot 100 may determine that the user may be tired or unfocused, and such user status information is sent to the handheld device 600. In another embodiment, the robot 100 obtains a facial image of the user, and extracts an image of the user's eye from the facial image. Image processor may determine whether the user's eyes are reddish. A reddish eye of the user may indicate the user's eyes are tired. Accordingly, the system may generate reminder through the robot 100 to advise the user to take a rest.

In one embodiment, when the user executes the application 660 of the handheld device 600 (e.g., a smart phone or a tablet), the application 660 may first generates a QR code. The robot 100 may perform authentication through scanning the QR code before establishing data connection with the handheld device 600. After the connection is completed, the handheld device 600 continues to execute the application 660. In another embodiment, the application 660 may prompt the user to log in, thereby accessing/recording the user's usage record. The login method may be performed through key pad input of the user's account password, through the fingerprint scanner on the handheld device, through performing face recognition through the handheld device 600 (or the image acquired by the camera device of the robot 100), or through the wearable device (such as a wristband or a Bluetooth watch) on the user.

When the user is operating the application 660, the robot 100 may respond correspondingly according to the instruction or the state of the user sent by the handheld device 100. For example, when the user completes a level of the application 660 or meets a predetermined condition, the handheld device 600 transmits a control signal to the robot 100. The robot 100 may generate a corresponding response, such as praising the user, performing a dance/singing gesture, playing a movie, and the like. The manner in which the robot 100 interacts with the handheld device 600 is described as follows.

A first scenario is when the application 660 is executed, the robot 100 takes instruction from the handheld device 600. The handheld device 600 determines whether to activate the robot 100 according to the usage status of the user. When the handheld device 600 determines to activate the robot 100, the handheld device 600 transmits detailed instructions and contents of the actions that the robot 100. Subsequently, the robot 100 executes an instruction to perform a corresponding operation. An advantage of this approach is that the robot 100 does not require the installation of self-automation programs, and is fully controlled by the handheld device 600. For example, when the application 660 is executed, the handheld device 600 can issue a voice command and text content, so that the robot 100 can play the text content by voice to guide the user to operate the application 660. In another case, in order to allow the robot 100 to perform an action correctly and avoid the data loss or corruption during real-time transmission, the handheld device 600 may package the instruction and the content into an executable file. When the robot 100 it may execute the executable upon receipt of the complete file. In one embodiment, the executable file is compatible with the operating system of the robot.

In the previous scenario, the robot 100 may require no pre-installed application or associated software, and is passively controlled by the handheld device 600. However, in a second scenario, the robot 100 may download and install the same application 660 or an auxiliary application associated with the application 660. The auxiliary application may be different from the application 660 installed on the handheld device 600 and cannot be used alone. In another embodiment, the auxiliary application is not available in the public app store, such as Apple's App store.

In one embodiment, the auxiliary application will confirm whether robot 100 is a compatible robot before installation. If the robot 100 not a compatible model, the auxiliary application will not be downloaded for installation. In another embodiment, the auxiliary application is to be installed on the robot 100 through an application on the handheld device 600. Specifically, the handheld device 600 first establishes connection with the robot 100, and the application on the handheld device 600 determines whether the connected robot is supported thereby. When the robot is determined to be compatible, the handheld device 600 transmits the auxiliary application to the robot 100. Alternatively, the handheld device 600 may transmit the download link of the auxiliary application to the robot 100, and a user may operate the user interface on the robot 100 to perform download operation.

In another embodiment, the auxiliary application includes control commands that correspond to several different types of robots, such that a single auxiliary application can enable the handheld device 600 to control different robots. Moreover, when the handheld device 600 is connected to the robot 100, the handheld device 600 can recognize the type of robot connected.

In another embodiment, the auxiliary application includes instruction conversion function. For example, the instruction sent by the application 660 on the handheld device 600 may be “mov fwd 10)” (move forward 10 steps). The auxiliary application may convert the application's instruction to a command that is readable by the particular type of robot 100 (for example, 0xf1h 10). The converted instruction code will then be transmitted to the robot 100 for execution.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A robot assisted interactive system, comprising:
a robot, a mobile device, a backend server, and a wearable device,
wherein the mobile device includes:
a display unit configured to display a visual content;
a touch control unit configured to receive user input;
a camera unit configured to obtain user reaction information;
a communication unit configured to establish data connection with the backend server and transmit the use reaction information thereto; and
a processing unit coupled to and configured to control the display unit, the touch control unit, the camera unit, and the communication unit; wherein the robot includes:
a gesture module configured to generate a gesture output according to the visual content;
a speech module configured to generate a speech output according to the visual content;
a communication module configured to establish data connection with the backend server; and
a control module coupled to and configured to control the gesture module, the speech module, and the communication module;
wherein the wearable device comprises a sensor configured to obtain a physiological information of a wearer;
wherein the backend server is configured to:
generate a feedback signal in accordance with the reaction information and send the feedback signal to the mobile device; so as to
cause the mobile device to update the visual content based on the feedback signal, and
cause the robot to generate updated gesture output and speech output based on the updated visual content.

2. The system of claim 1, wherein the wearable device comprises:
a transceiver configured to send the physiological information to the mobile device; and
a processer coupled to and configured to control the sensor and the transceiver.

3. The system of claim 1, wherein the wearable device is a brainwave detection and analysis device, and the sensor is a brainwave detection electrode module.

4. The system of claim 1, wherein the robot further comprises a camera module configured to obtain user reaction information.

5. A method of robot assisted interaction using a robot assisted interaction system that includes a robot, a mobile device, and a backend server, the method comprising:
establishing data connection between the mobile device and the robot;
displaying, on the mobile device, a first visual content, wherein the robot generates a first speech output and a first gesture output based on the first visual content;
determining, by the mobile device, a receipt of a user input signal; upon receipt of the user input signal by the mobile device, displaying on the mobile device a second visual content based on the user input signal, wherein the robot generates a second speech output and a second gesture output based on the second visual content;
obtaining a use reaction information;
sending the user reaction information to the backend server;
generating a feedback signal, by the backend server, based on the user reaction information, and sending the feedback signal to the mobile device; and
displaying, on the mobile device, a third visual content, wherein the robot generates a third speech output and a third gesture output based on the third visual content.

6. The method of claim 5, further comprising:
providing a wearable device to obtain a user physiological information;
sending the user physiological information to the backend server, and
generating, by the backend server, the feedback signal based on the user physiological information.

7. The method of claim 5, wherein the physiological information includes a user image information and a user voice information.

8. The method of claim 5, wherein establishing data connection between the mobile device and the robot comprises:
receiving a user information from the backend server by the mobile device.

9. A robot interaction system, comprising:
a wearable device, adapted to be worn by a user, configured to detect a physiological information of the user;
a mobile device configured to execute an application and receive an interaction information of the user;
a backend server that generates a feedback signal based on the interaction information; and
a robot coupled to the mobile device;
wherein when the mobile device receives the feedback signal, the application changes a display or speech output of the mobile device, and robot generates a corresponding gesture output based on the feedback signal.

10. The system of claim 9, wherein the mobile device further comprises a camera unit configured to obtain user reaction information, wherein the interaction information is generated based on the reaction information.

11. The system of claim 9, wherein the application operates to generate a visual content on the mobile device, wherein the robot is configured to generate a gesture output and a speech output according to the visual content.

12. The system of claim 9, wherein the robot further comprises a camera module configured to obtain user reaction information and transmit the user reaction information to the mobile device, wherein the interaction information is generated based on the user reaction information.

13. The system of claim 9, wherein the wearable device includes a brainwave detection and analysis device.

14. The system of claim 9, wherein the robot further comprises a projection module configured to project an image.

15. The system of claim 9, wherein the interaction information is generated based on a visual information or a speech information.
